(19) United States
(12) Patent Application Publication
(10) Pub. No.: US 2019/0344221 A1
(43) Pub. Date: Nov. 14, 2019

(54) SYSTEM AND METHOD FOR PREVENTING MEMBRANE FOULING IN REVERSE OSMOSIS PURIFICATION SYSTEMS UTILIZING HYDRODYNAMIC CAVITATION

(71) Applicant: Michael Smith, Placentia, CA (US)

(72) Inventor: Michael Smith, Placentia, CA (US)

(21) Appl. No.: 15/974,556

(22) Filed: May 8, 2018

(51) Int. Cl. B01D 65/08; B01D 61/02; B01D 61/12; C02F 1/44; C02F 1/34

(52) U.S. Cl. CPC B01D 65/08; B01D 61/025; B01D 61/022; B01D 61/12; C02F 2101/103; C02F 1/34; B01D 2321/2033; B01D 2311/04; C02F 1/441

(57) ABSTRACT

The present disclosure provides a method for preventing membrane fouling in a fluid treatment system having at least one membrane. The method describes hydrodynamically cavitating a fluid flow prior to injecting it into the fluid treatment system and through the at least one membrane, wherein after undergoing hydrodynamic cavitation in the cavitation reactor, solid components in the fluid change their (i) molecular structure, (ii) a charge, or both, such that the components repulse each other and disperse around an edge of the membrane to prevent fouling. A system for preventing membrane fouling in a fluid treatment system having at least one membrane is also provided.

### CROSS-REFERENCE TO RELATED APPLICATIONS

This application claims the benefit of U.S. Provisional Application No. US62/503,313, filed May 8, 2017.

### FIELD OF THE INVENTION

The present invention relates generally to remediation of fluids, and more particularly, a system and method for utilizing hydrodynamic cavitation to prevent or obviate membrane fouling and/or scaling as it pertains to fluid treatment systems, generally, and to reverse osmosis (RO) systems, more specifically.

### BACKGROUND OF THE INVENTION

The many diverse activities of humans produce innumerable waste materials and by-products. As the environmental, health and industrial impact of pollutants increase, it has become increasingly important to develop new methods for the rapid and efficient removal of a wide range of contaminants from polluted waters and other liquids. Remediation, as it is often referred to, aims to reduce or eliminate pollutants and other unsafe materials from fluid.

Many methods of remediation exist. Some biological treatment techniques include bioaugmentation, bioventing, biosparging, bioslurping, and phytoremediation. Some chemical treatment techniques include ozone and oxygen gas injection, chemical precipitation, membrane separation, ion exchange, carbon absorption, aqueous chemical oxidation, and surfactant enhanced recovery. Some chemical techniques may be implemented using nanomaterials. Physical treatment techniques include, but are not limited to, pump and treat, air sparging, and dual phase extraction.

One example of a remediation technique that incorporates the use of membrane technology is reverse osmosis (RO), which is a water purification technology that uses a semipermeable membrane to remove ions, molecules, and larger particles from contaminated water by pushing water under pressure through a semi-permeable membrane, which is a membrane that will allow the passage of water molecules but not the majority of dissolved salts, organics, bacteria, and pyrogens.

RO works by using a high-pressure pump to increase the pressure on the salt side of the RO and force the water across the semi-permeable membrane, leaving almost all of dissolved salts behind in the reject stream. The desalinated water that is demineralized or deionized is called permeate water. The water stream that carries the concentrated contaminants that did not pass through the RO membrane is called the reject (or concentrate) stream. As the feed water enters the RO membrane under pressure, the water molecules pass through the semi-permeable membrane and the salts and other contaminants are not allowed to pass and are discharged through the concentrate stream. In some RO systems, the concentrate stream can be fed back into the RO system through the feed water supply and recycled through the RO system. The water that makes it through the RO membrane is called permeate or product water and usually has around 95%-99% of the dissolved salts removed from it.

Reverse osmosis can remove many types of dissolved and suspended species from water, including bacteria, and is used in both industrial processes and the production of potable water. The result is that the solute is retained on the pressurized side of the membrane and the pure solvent is allowed to pass to the other side. To be “selective”, this membrane should not allow large molecules or ions through the pores (holes), but should allow smaller components of the solution (such as solvent molecules) to pass freely. The solute, many times, include silica, barium and other solids. An example of a RO membrane is disclosed in U.S. Pat. No. 4,277,344, which describes an aromatic polyamide film which is the interfacial reaction product of an aromatic polyamine having at least two primary amines substituents with an aromatic acyl halide having at least three acyl halide substituents.

While RO is itself efficient, problems exists due to what is referred to as “membrane fouling,” which occurs when contaminants accumulate on the membrane surface effectively plugging the membrane and drastically reducing its remediation effectiveness. Fouling typically occurs in the front end of a RO system and results in a higher pressure drop across the RO system and therefore a lower permeate flow. Fouling mainly stems from three sources, namely: (i) particles in the feed water (e.g. solute or concentrate); (ii) buildup of sparsely soluble minerals; and (iii) byproducts of microorganism growth. Because of fouling, membranes must be cleaned frequently, which is costly and overall reduces the efficiency of the system by requiring more maintenance. In addition, cleaning the membranes is often expensive and leads to shorter service life of the membrane elements. This is especially true when more than one fouling condition prevails, which can leave the membrane irreversibly fouled with the only suitable solution is the complete replacement of the membrane elements.

Several pre-treatment methods using both mechanical and chemical treatments have been suggested to diminish membrane fouling. For example, antiscalant may be injected into the supply prior to reaching the RO membrane. However, this only delays the scale formation process. This delay is sufficient to avoid precipitation of calcium carbonate and calcium sulfate on the membrane surface. As this delay is for a finite period, scaling can take place in systems on shut down. Another example is that dispersant can be injected in the feed water. Dispersants keep fine suspended solids from coagulating and coming down on the membrane surface. Proper use of dispersants can minimize fouling due to problem particulates that are difficult to pre-filter. However, dispersants have the same problems as anti-scalents. For example, U.S. Pat. No. 6,365,101 discloses a method for inhibiting scale deposits in an aqueous system comprising a comprises at least one of polyvalent metal silicate and polyvalent metal carbonate, wherein the aqueous system has a pH of at least about 9, and wherein a mean particle size of the anti-scalant is less than about 3 microns.

Another pre-treatment solution includes the use of a multi-media filter to help prevent fouling. A multi-media filter typically contains three levels of media consisting of anthracite coal, sand and garnet, with a supporting layer of gravel at the bottom. The filter media arrangement allows the largest dirt particles to be removed near the top of the media bed with the smaller dirt particles being retained deeper in the media. This allows the entire bed to act as a filter allowing much longer filter run times and more efficient particulate removal. Further methods also include the use of microfiltration membranes, water softeners that help exchange scale forming ions with non-scale forming ions, insertion of sodium bisulfit, and granular activate carbon.

However, these current pretreatment methods can be costly and fouling still occurs at a rate at which it may be deemed inefficient. Furthermore, regardless of the level of care taken, fouling will take place eventually to some extent given the extremely fine pore size of a RO membrane no matter how effective your pretreatment and cleaning schedule is.

As such, post-treatment methods have also been suggested as well. For example, methods to change the electrical charge of the membrane surface to repel certain solutes have been proposed, as has certain coating for membrane surfaces been disclosed. For example, U.S. Pat. No. 6,913,694 describes aa selective membrane is a composite polyamide reverse osmosis membrane in which a hydrophilic coating has been applied to the polyamide layer of the membrane, the hydrophilic coating being made by (i) applying to the membrane a quantity of a polyfunctional epoxy compound, the polyfunctional epoxy compound comprising at least two epoxy groups, and (ii) then, cross-linking the polyfunctional epoxy compound in such a manner as to yield a water-insoluble polymer.

Further, U.S. Pat. No. 9,089,820 describes a selective membrane that is a composite polyamide reverse osmosis membrane having a hydrophilic coating made by covalently bonding a hydrophilic compound to the polyamide membrane, the hydrophilic compound including (i) a reactive group that is adapted to covalently bond directly to the polyamide membrane, the reactive group being at least one of a primary amine and a secondary amine; (ii) a non-terminal hydroxyl group; and (iii) an amide group. In another embodiment, the hydrophilic compound includes (i) a reactive group adapted to covalently bond directly to the polyamide membrane, the reactive group being at least one of a primary amine and a secondary amine; (ii) a hydroxyl group; and (iii) an amide group, the amide group being linked directly to the hydroxyl group by one of an alkyl group and an alkenyl group.

However, these methods have achieved only moderate success, can be expensive, and also make cleaning the membranes more difficult. Accordingly, there is a need for an improved system and method to prevent membrane fouling. One potential solution would be the use of hydrodynamic cavitation prior to the contaminated water being fed through the RO membrane.

Cavitation, generally, is the formation of vapor cavities in a liquid that creates small liquid-free zones. In engineering terminology, the term cavitation is used in a narrower sense, namely, to describe the formation of vapor-filled cavities in the interior or on the solid boundaries created by a localized pressure reduction produced by the dynamic action of a liquid system.

In hydrodynamic cavitation, decontamination may be achieved through the use of submerged jets which trigger hydrodynamic cavitation events in the liquid. These cavitation events drive chemical reactions by generating strong oxidants and reductants, and efficiently decomposing and destroying contaminating organic compounds, as well as some inorganics. These same cavitation events both physically disrupt or rupture the cell walls or outer membranes of microorganisms (such as E. coli and Salmonella) and larvae (such as Zebra mussel larvae), and also generate bactericidal compounds, such as peroxides, hydroxyl radicals, etc., which assist in the destruction of these organisms. Following disruption of the cell wall or outer membrane, the inner cellular components are susceptible to oxidation.

Cavitation technology has uses in a wide variety of industrial and ecological remediation settings, including but not limited to farming, mining, pharmaceuticals, food and beverage manufacture and processing, fisheries, petroleum and gas production and processing, water treatment and alternative fuels. With such a wide field of use, companies have been increasingly eager to further develop cavitation technologies.

Some examples include the use of rotating jet nozzles for cleaning and maintenance purposes disclosed in U.S. Pat. No. 5,749,384 (Hayasi, et al.) and U.S. Pat. No. 4,508,577 (Conn et al.). The apparatus of Hayashi employs a driving mechanism capable of causing the jet nozzle itself to travel upward-and-downward, to rotate and swing. Conn et al. describe the rotation of a cleaning head including at least two jet forming means, for cleaning the inside wall of a conduit.

These current hydrodynamic cavitation technologies, in many cases, aim to reduce particle distribution size of suspended solids, such as the kind often found in RO to be the cause of membrane fouling. Despite the advances in utilizing cavitation, there has remarkably been little to no use of cavitation in combination with RO that can take advantage of the benefits of cavitation to assist in preventing membrane fouling. Accordingly, there is a need for a new system and method incorporation hydrodynamic cavitation into RO to create a more efficient and effective RO process that also reduces the likelihood of membrane fouling.

### SUMMARY OF THE INVENTION

The following summary of the invention is provided in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

To achieve the foregoing and other aspects and in accordance with the purpose of the invention, a system and method for preventing membrane fouling in a fluid treatment system.

In an embodiment of the present invention, a system is provided to prevent membrane fouling, the system for preventing membrane fouling in a fluid treatment system having at least one membrane, the system comprising a hydrodynamic cavitating reactor for cavitating a fluid flow prior to injecting it into the fluid treatment system and through the at least one membrane; wherein after undergoing hydrodynamic cavitation in the cavitation reactor, solid components in the fluid change their (i) molecular structure, (ii) a charge, or both, such that the components repulse each other and disperse around an edge of the membrane to prevent fouling.

In an embodiment of the present invention, a method for preventing membrane fouling in a fluid treatment system having at least one membrane is provided. The method comprises hydrodynamically cavitating a fluid flow prior to injecting it into the fluid treatment system and through the at least one membrane; wherein after undergoing hydrodynamic cavitation in the cavitation reactor, solid components in the fluid change their (i) molecular structure, (ii) a charge, or both, such that the components repulse each other and disperse around an edge of the membrane to prevent fouling.

This method is useful in areas such as industrial and ecological remediation settings, including, for example, municipal drinking water, de-salination, farming, mining, pharmaceuticals, food and beverage manufacture and processing, fisheries, petroleum and gas production and processing, water treatment and alternative fuels. Particularly, the system and method is useful in settings that utilize filters having membranes that are prone to fouling, such as in reverse osmosis systems and water desalinization.

Another object of the present invention is to provide a new and improved system and method that is easy and inexpensive to construct.

Other features, advantages, and aspects of the present invention will become more apparent and be more readily understood from the following detailed description, which should be read in conjunction with the accompanying drawings.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a schematic diagram of a fluid remediation system incorporating hydrodynamic cavitation in accordance with one embodiment of the present invention;

FIG. 2 is a block diagram of a fluid remediation system incorporating hydrodynamic cavitation in accordance with one embodiment of the present invention;

FIG. 3 is a step-wise flow chart for a method for performing fluid remediation incorporating hydrodynamic cavitation in accordance with one embodiment of the present invention;

FIG. 4 is a front view of the membranes used in reverse osmosis in accordance with one embodiment of the present invention;

FIG. 5 is a flow diagram illustrating an example method for cavitation-based water remediation in accordance with one embodiment of the present invention;

FIG. 6 is a schematic diagram of a use case detailing remediation in a farm using a fluid remediation system in accordance with one embodiment of the present invention;

FIG. 7 shows data taken from a test case utilizing the systems and methods provided for herein to perform remediation;

FIG. 8 is a front view of the reactor plate utilized in the hydrodynamic cavitation system in accordance with one embodiment of the present invention; and

FIG. 9 is a schematic of a fluid remediation system utilizing hydrodynamic cavitation together with an intelligent platform and automation hardware/software arrangement in accordance with one embodiment of the present invention.

Unless otherwise indicated illustrations in the figures are not necessarily drawn to scale.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

As used herein, the term “concentrate stream” shall mean the stream of water that carries the concentrated contaminants that did not pass through the RO membrane. Reject water may also be referred to herein as the “reject stream.”

As used herein, the term “contaminated water” shall mean water molecules in combination with dissolved salts, organics, bacteria and pyrogens.

As used herein, the term “permeate water” shall mean the desalinated water that is demineralized or deionized after passing through an RO membrane. Permeate water may also be referred to herein as “product water.”

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

While exemplary embodiments of the present invention will be described with reference to certain industries in which cavitation finds use, a skilled artisan will realize that embodiments of the invention are applicable to any type application in which cavitation is beneficial.

The system and method of the present invention prevent membrane fouling and remediate fluids. The system is configured to change the molecular and/or structural characteristic of the organic and inorganic species of concentrate that in normal circumstances clogs or fouls membranes in filtration systems. The detailed elements and specific embodiments of the present decontamination system can be best appreciated by further understanding the cavitation phenomenon employed to drive the physical and chemical decontamination reactions. Due to large pressure drop in flow, microscopic bubbles grow in the regions of pressure drop and collapse in the regions of pressure rise. When subjected to cavitation, various molecules in the liquid undergo dissociation and form free radicals, which are powerful oxidizing or reducing agents. For example, in aqueous liquids, the dissociation of water to form hydroxyl radicals occurs under intense cavitation due to the growth and collapse of microscopic bubbles. Analogous dissociation of other molecules may occur as a result of cavitation in aqueous solutions as well as in non-aqueous liquids and solutions, producing radicals which similarly aid in the decontamination reactions described herein. Moreover, cavitation generated in any liquid environment will result in the physical disruption of contaminants, without regard to the generation of particular radicals. The methods and systems of this invention will be applicable for all fluid environments comprising contaminants susceptible to decomposition via the physical and/or chemical effects of the cavitation employed.

The inventors have found that using the system and methods described herein, the concentrate changes form and does not foul the membranes of a RO membrane, as described herein. The inventors have also found that the system and methods are useful in other types of filtration utilizing membrane technology.

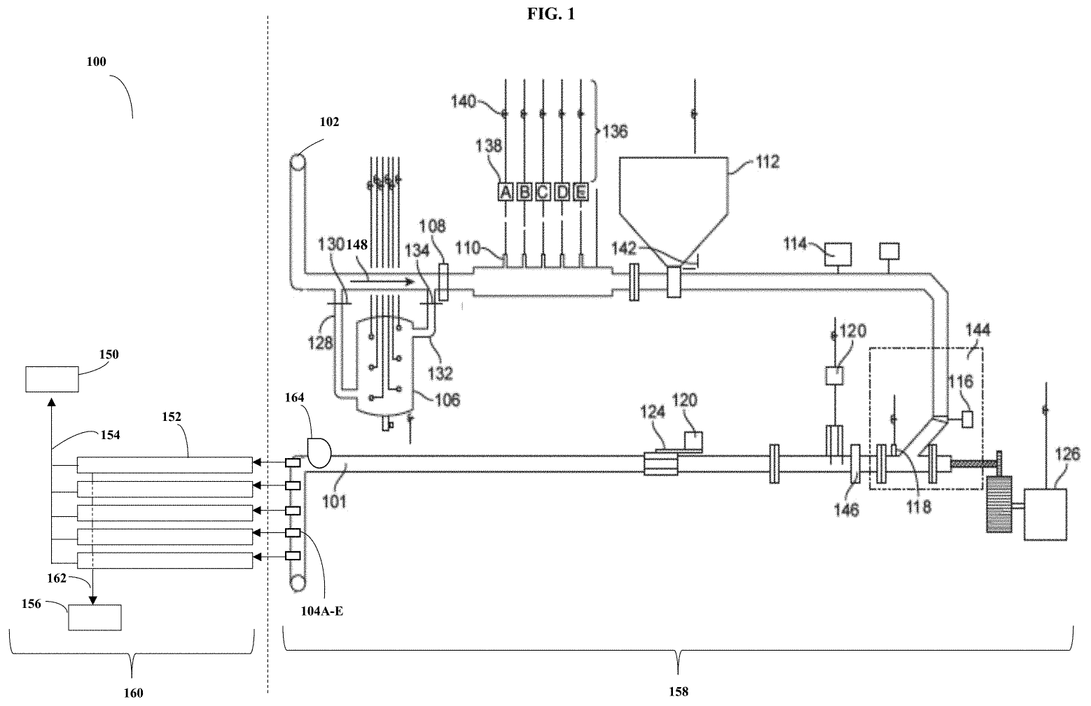

Referring now to FIG. 1, a schematic diagram of a fluid remediation system incorporating hydrodynamic cavitation in accordance with one embodiment of the present invention, is presented generally at 100. The system 100 defines a hydrodynamic cavitation system 158 coupled with an inlet 102, as well as various outlets 104A-E and a RO membrane 160. In the current embodiment, there is one inlet 102 and 5 outlets 104A-E, but in optional embodiments, there may be more or less number of inlets and/or outlets.

Still referring to FIG. 1, the remediation channel 101 is configured to introduce contaminated water into the system 100 along a path represented by 162, using a pump 126. Contaminated water passing through the remediation channel 101 may initially be raw, brown or black and may contain sediment, pollutants, and the like, and will be introduced into the hydrodynamic cavitation system 158 by the pump 126 that is coupled to the hydrodynamic cavitation system 158. The pump 126 is used to supply contaminated water into the hydrodynamic cavitation system 158 for processing.

In the current embodiment, there is only one pump 148 which is configured to operate at a high pressure. In optional embodiments, the pump 148 may be operated at a different pressure to account for the concentration of different types of contaminants found within the contaminated water (e.g., arsenic, lead, radium, cadmium, and zinc). In even other optional embodiments, more than one pump 148 may be used.

Although simple rectangular tanks are illustrated in FIG. 1, it should be understood that various sizes, shapes, vessel locations and numbers of components of various sizes may be employed.

Still referring to FIG. 1, beginning now at the inlet 102, the system comprises a sensor housing 106, a first valve 108, a plurality of injector coils 110, an additive port 112, and a flow meter 114. As used herein, this area of the system may be referred to as “pre-cavitation zone” or “mixing zone.” The system may further comprise a first air injector 116 and a second sensor array 118, followed by vortex plate 146 and a second air injector 120. Additional sensors (e.g., pressure sensor 124) and a second valve 122 are also shown. The remediation pathway 101 then continues to the outlet 104. As used herein, this area of the system may be referred to herein as “cavitation zone” 144.

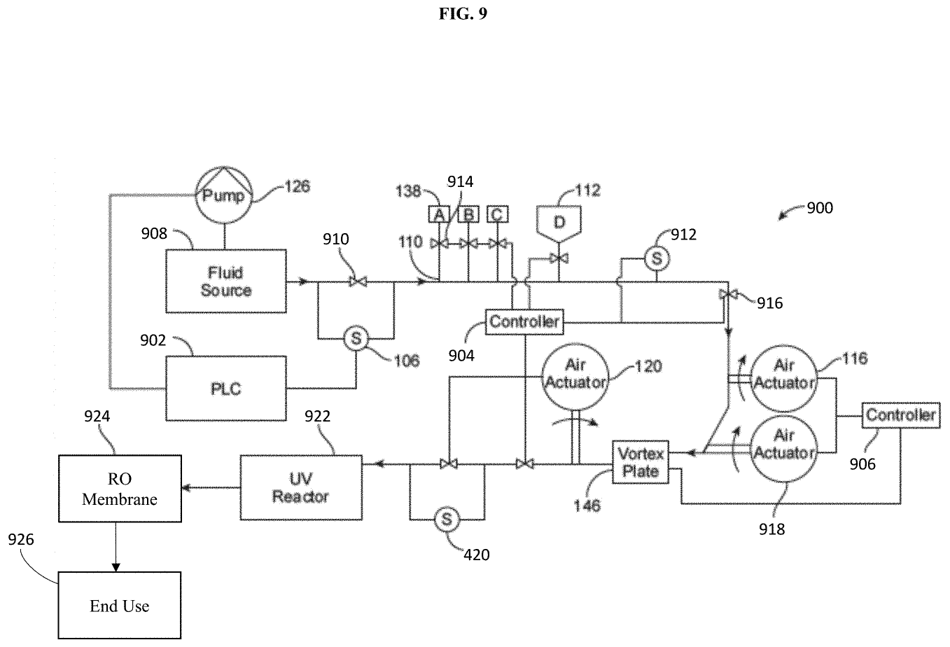

Still referring to FIG. 1, a sensor housing 106 is positioned proximate to the inlet 102 and is communicatively coupled to the remediation pathway 101 such that the remediated contaminated water is tested and monitored prior to entering the pre-cavitation zone. In optional embodiments of the present invention, a divergence pathway 128 and a valve 108 are provided such that a sample of the remediation fluid is off-shot for testing. An ingress pathway 132 is further provided for injecting the testing fluid back into the remediation channel 101 via a valve 134 (e.g., choke valve) coupled to the ingress pathway 132. The sensor housing 106 may comprise an array of sensors used for automation, characterization, and monitoring of the process. For example, the sensor array may comprise a number of different components, including mechanical sensors, electronics, analytical and chemical sensors, control systems, telemetry systems, and software allowing the sensor to communicate with a Programmable Logic Controller (PLC), which is discussed in greater detail in relation to FIG. 9.

Still referring to FIG. 1, in the current embodiment of the present invention, the sensor housing 106 may comprise mechanical sensors, flow meters to measure flow rate and pressure gauges, electronic sensors to measure a variety of parameters such as pressure, specific gravity, the presence of liquid (water level meters and interface probes), pH, temperature, and conductivity, and analytical sensors to measure chemical parameters such as contaminant concentrations. Some examples of analytical sensors include pH probes and optical sensors used for colorimetric measurement. Control systems that work in conjunction with sensors comprise PLCs and other electronic microprocessor devices. Control systems are able to receive sensory inputs, process information, and trigger specific actions. These will be discussed in greater detail with relation to FIG. 9.

Still referring to FIG. 1, a plurality of leads 136 are fluidly coupled to the remediation channel 101, the leads 136 being configured to inject certain substances into the remediation channel 101. By way of example, different types and combinations of precursor compounds in solid, liquid or gas phase depending upon the type of fluid treatment process selected, the contaminants to be treated, the existing water quality, the desired water quality, and other variables may be employed. The precursor compounds 140 may be pumped into or injected into the remediation channel 101 via pumps 138A-E. In the current embodiment, five pumps 138A-E are used, but in optional embodiments, more than five pumps may be used. The precursor compounds 140 can be feedstocks but also may comprise replaceable cartridges, and line feeds or other such like chemical inputs and for larger water flows bulk supply of the various feed stocks and precursor feed materials.

Still referring to FIG. 1, exemplary precursor compounds 140 include compounds that may comprise halogen salts such as fluorine, chlorine, bromine, iodine, sulfate salts, sodium, potassium and the like, introduced as solids or dissolved in water or some other solvent. Liquid feed stocks such as ozone, hydrogen peroxide, peroxy acids, brine solutions, chlorine solutions, ammonia solutions, amines, aldehydes, ketones, methanol, chelating agents, dispersing agents, nitrides, nitrates, sulfides, sulfates, and the like, dissolved in water or some other solvent may be employed. Further, gaseous feed stocks such as ozone, air, chlorine dioxide, oxygen, carbon dioxide, carbon monoxide, argon, krypton, bromine, iodine and the like may be employed, each of the foregoing in predetermined amounts based on the fluid remediation project goals. For solid compounds, an additive port 112 is shown. Injection of dry agents may occur via manipulation of the valve 142 coupled to the additive port 112.

Still referring to FIG. 1, the port 112 for introducing the agents into the remediation channel 101 may introduce the oxidizing agents into the flow-through channel at or near the local constriction of flow. In the illustrated example, the port may be configured to permit the introduction of the oxidizing agent into the fluid in the local constriction of flow. It will be appreciated that the ports may be configured to introduce oxidizing agents into the remediation channel 101 not only at the local constriction of flow, but along an area between and including the local constriction of flow and the area into the cavitation zone, where cavitation bubbles are formed.

Still referring to FIG. 1, and moving down the remediation channel 101, additional sensors such as a flowmeter 114 is placed along the path. In the pre-cavitation zone, the flow-meter is configured to quantify the bulk fluid movement so as to allow the PLC to calculate cavitation variables, which is discussed in greater detail with reference to FIG. 9. Once the contaminated water enters into cavitation zone 144, the fluid undergoes varying degrees of cavitation. The cavitation zone 144 may comprise a first air injector 116 configured to inject air into the remediation channel 101, a reactor plate 146, a second air injector 120, and control valves 124 to control the proportion of flow through the cavitation zone 144 and to control the average dwell time of fluid in the remediation channel 101.

Still referring to FIG. 1, the first air injector 116 and the second air injector 120 are configured to induce cavitation into the fluid to form vapor cavities in a liquid (i.e. small liquid-free zones, bubbles or voids), which occurs when the fluid is subjected to rapid changes of pressure that cause the formation of cavities where the pressure is relatively low. In this way, the injectors are used to enhance chemical reactions and propagate reactions due to free radical formation in the process due to disassociation of vapors trapped in the cavitating bubbles.

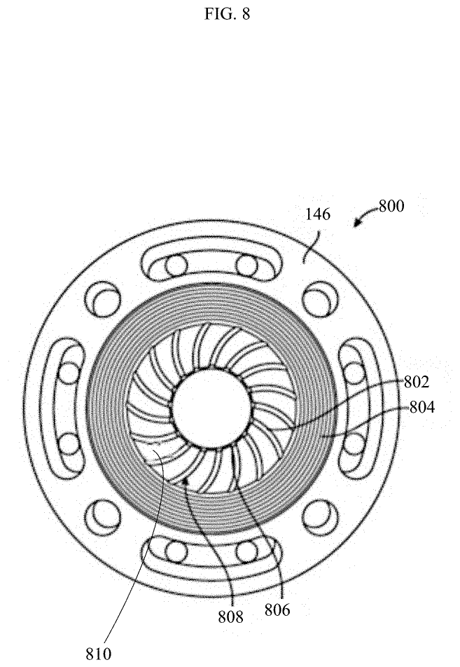

Still referring to FIG. 1, a reactor plate 146 is disposed within the remediation channel 101 between the first air injector 116 and the second air injector 120. The reactor plate, discussed in greater detail with relation to FIG. 8, is configured to induce further cavitation such that, in the cavitation zone 144, there are large quantities of micro bubbles having high volatility. When these micro bubbles collapse, instantaneous pressures up to 500 atmospheres and instantaneous temperatures of about 5000 degrees K are produced in the fluid. This phenomenon accomplishes several important chemical reactions: (1) H2O disassociates into OH radicals and H+ atoms; (2) chemical bonds of complex organic hydrocarbons are broken; and (3) long chain chemicals are oxidized into simpler chemical constituents, before being irradiated downstream by ultraviolet radiation, furthering the oxidation process.

Still referring to FIG. 1, an additional valve 124, which in the current embodiment is a butterfly valve but in other embodiments may be comprised of other types of valves, is disposed of in the remediation channel 101 to drop the head pressure when needed for egress of the fluid to the outlets 104A-E. The valve 124, like other valves in the system, is communicably coupled to the PLC such that it is fully autonomous.

Still referring to FIG. 1, once the fluid has passed through the cavitation zone 144, it will be fed through the remediation channel 101 towards the RO membrane 152. A RO pump 160 is coupled to the remediation channel 101 ensure that the proper amount of generated so that RO can occur across the RO membrane 152. Once at the outputs 104A-E, the fluid will pass through to the RO membrane 152 where it will undergo RO. As the contaminated water enters the RO membrane 152 under pressure (enough to overcome osmotic pressure) the water molecules pass through the RO membrane 152 and the salts and the other contaminants are not allowed to pass and are discharged through the concentrate stream 162 and stored in the concentrate container 156. The permeate that makes it through the RO membrane 152 will pass through the permeate channel 154 and will be stored in the permeate container 150.

It was found that once the fluid passed through the cavitation reactor of FIG. 1, the filters of the RO fouled at a significantly slower rate and significantly extended membrane life. Further, it was found that after processing 7 MG per day of brackish well water into drinking water, the system recovered between 55-65% of RO concentrate, which was previously untreatable and without fouling the membranes. Table as shown in Table 1, in which each vertical axis represents a week:

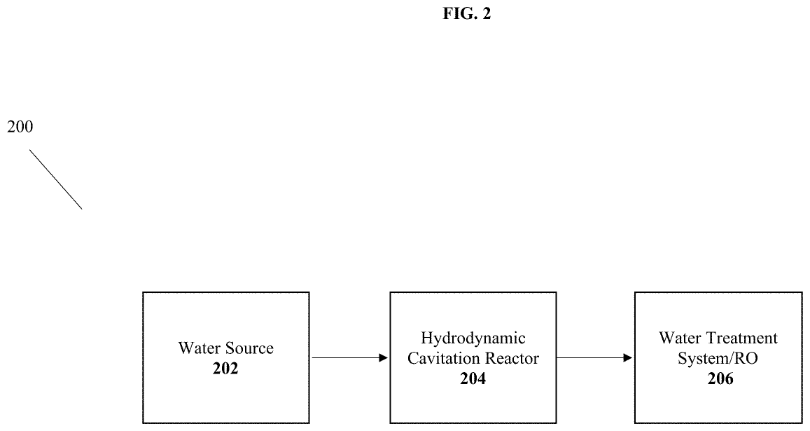

The filters did not foul at nearly the same rate when RO ran by itself, this being s=discussed with relation to FIGS. 2-4.

Referring now to FIG. 2, a block diagram of a fluid remediation and/or treatment system incorporating hydrodynamic cavitation in accordance with one embodiment of the present invention, is shown generally at 200. A water source 102 is provide, which is either pumped to or otherwise received by a hydrodynamic cavitation reactor 204. In the current embodiment, hydrodynamic cavitation is discussed. However, in optional embodiments it should be noted that other types of cavitation may be used with the subject system and method such as but not limited to acoustic cavitation and the like. Once the fluid undergoes cavitation in the hydrodynamic cavitation reactor 204, it is then received by the second fluid treatment system 208, which in this exemplary embodiment, comprises any system which utilizes filters having membranes to remediate contaminated water.

An example of wastewater treatment using membrane technology is RO. RO may utilize, for example, membranes that are spiral wound elements which comprise a sandwich consisting of two membrane sheets with an inserted permeate carrier is glued together and a feed spacer is inserted between the opposing membrane surfaces to complete the membrane package. The membrane package is wound around a perforated central tube through which the permeate exits the element. In a typical setting, the membranes will collect permeate which act as a “fouling layer.” The fouling layer typically consists of colonies of microbes, salts and inorganics such as Al, As, Ch, Co, Mg, BaSO₄, O, S, Ni, P, Si, Fe, Ba and Sr and the like.

After undergoing cavitation in the reactor 204, the components in brackish or brown water change their molecular structure and/or charge of the molecules of the precipitate to make them “naturally” disperse and not clog or foul the membrane. In this way, cavitating the fluid, or even cavitating the concentrate after a first run through a RO membrane, as a pre-treatment method and remediation technique reduce the likelihood of the RO membrane being subject to clogging or fouling. If cavitation is used at a “first pass”, effective pre-treatment of RO feed water (for complete or partial removal of potential foulants such as particulates, colloids, and organic matter).

It was found that the buildup on the outside of the filters consisted of a fine white powder containing small amounts of larger aggregates, and strongly resembles the appearance of corn starch. The power was analyzed via ICP/OES to detect inorganic components present in the sample. Given the results of solubility tests, it was suspected the powder to be a heterogeneous mixture of insoluble salts. Any metallic components detected by elemental analysis can thus be assumed to be the cationic species in these salt crystals. By far the most abundant metal was found to be calcium, followed by magnesium and potassium. Molar ratios between these metals were determined as follows: Calcium: Magnesium (mole: mole) 18.6:1 and Calcium: Potassium (mole: mole) 114:1. Trace amounts of the following metals were also detected (less than 1 ppm each): barium, cobalt, copper, molybdenum, nickel, titanium, vanadium, zinc and silver. The following elements were detected by the instrument and produced reliable spectra, but we were unable to quantify them: carbon, sulfur and phosphorous.

In order to determine the anionic components of the powder, a small sample was analyzed via ion chromatography (IC). The anions tested for were fluoride, chloride, nitrite, sulfate, bromide, and phosphate. Since nitric acid was used to dissolve the powder, we were unable to test for nitrate.

Based on the available data, it was concluded the powder in question is primarily composed of calcium sulfate (>90%) with magnesium sulfate and trace amounts of the aforementioned metals making up the remaining portion of the powder. Although this conclusion was reached largely by qualitative means, it is supported by observed empirical data and the known properties of calcium sulfate. The literature value for calcium sulfate's solubility product (KSP) is 9×10−6, which is consistent with our observation of the powder being sparingly soluble in water. Both calcium sulfate and magnesium sulfate also appear as white powders, which matches the physical appearance of the powder analyzed by the laboratory.

Finally, based on data from the input streams there appears to be a known source for calcium and magnesium to enter the hydrostatic cavitation apparatus. Water quality analysis of the concentrate input steam found both calcium and magnesium to be present at high levels. There appears to be a process by which these two cations react with sulfate to form insoluble aggregates in the hydrostatic cavitation process, which aids in avoiding filter fouling.

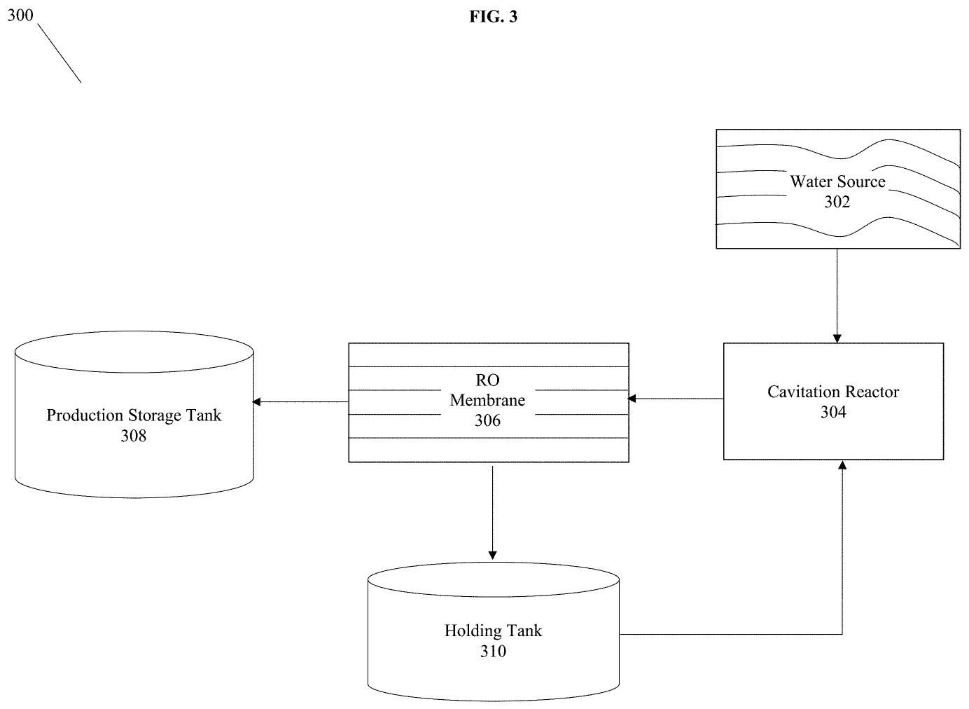

Referring now to FIG. 3, a step-wise flow chart for a method for performing fluid remediation incorporating hydrodynamic cavitation in accordance with one embodiment of the present invention, is presented generally at 300. In this system, contaminated water from a water source 302 is pumped into or received by the cavitation reactor 304. Once the RO membrane 306 receives the contaminated water that has undergone cavitation, it performs reverse osmosis and sends the filtered production water to the production storage tank 308, and the concentrate stream together with fluid that is not ready for consumption to the holding tank 310. At the holding tank 310, the fluid settles and particulate settles to the bottom. Fluids having concentrate is then sent back to the cavitation reactor 304 where it undergoes hydrodynamic cavitation such as described herein before being reprocessed by the RO membrane 306.

During testing, not only did approximately 55-65% of the fluid get reclaimed and become useable for production water, after running the contaminated water through the cavitation reactor 304, the RO membrane 306 did not foul as they did if the contaminated water didn't undergo cavitation at all. Instead, the pressure on the membranes was maintained at an approximately stable pressure throughout daily cycles. Under “normal” circumstances in RO, pressure on the membranes builds throughout the process as precipitate builds up. An examination of the filters showed that once the contaminated water was run through the cavitation reactor 304, the fouling layer did not build up on the RO membranes 306, or at least, built up at a much lower rate. The RO membrane 306 comprises a plurality of membranes having in exemplary embodiments pore sizes range from 0.0001 μm to 0.001 μm such that is able to retain mostly all molecules except for water and due to the size of the pores, the required osmotic pressure is significantly greater than other forms of filtration. Thus, particulate build up may occur and foul the RO membrane 306, and also, cause a loss of production capacity and increase the pressure until a failure condition, at times, may occur.

Still referring to FIG. 3, in this exemplary embodiment, the contaminated water from the water source 302 is sent directly to the cavitation reactor 304. In optional embodiments, however, the contaminated water from the water source 302 may first undergo RO and be passed through its own RO membrane before being sent to the cavitation reactor 304.

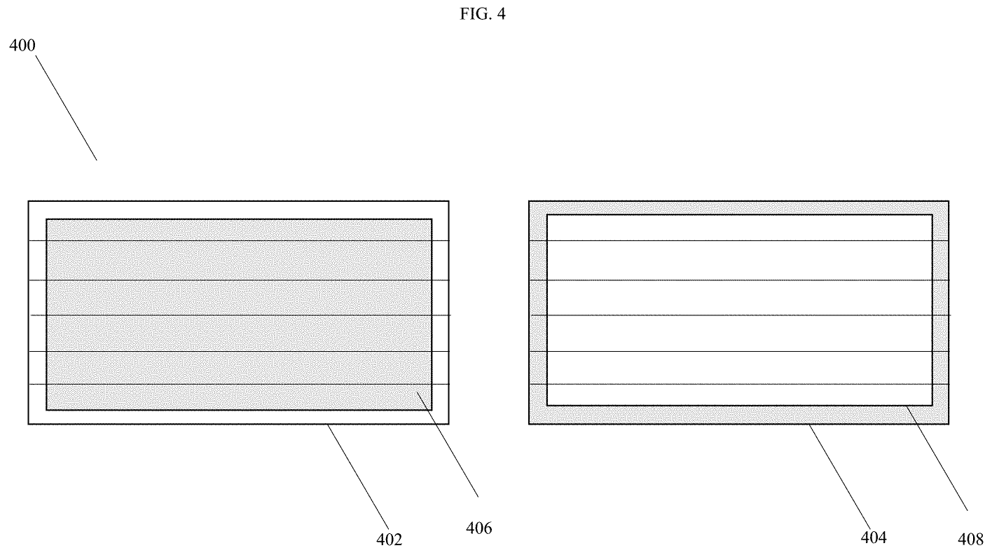

Referring now to FIG. 4, a front view of the membranes used in reverse osmosis in accordance with one embodiment of the present invention, is presented generally at 400. In the current embodiment, membranes 402 and 404 are shown. Membrane 402 was run with fluids that had not gone through the cavitation processes as described herein, whereas membrane 404 displays a membrane that has had fluids run through it which have passed through the cavitation process as described herein. As can be seen, a fouling layer and its particulate 406 built up on the inner portions of the membrane, whereas in membrane 404, minimal fouling layer particulate built up on the outer portion of the membrane 408. This means that LP membranes can be used as opposed to HP membranes, saving significantly on costs.

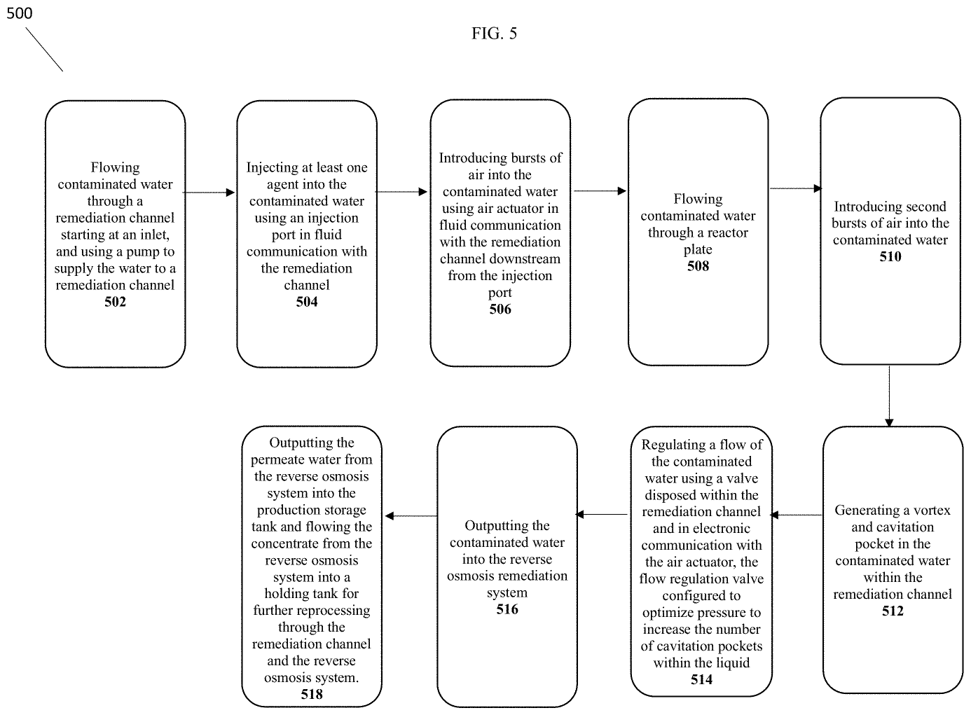

Referring now to FIG. 5 a flow diagram illustrating an example method for cavitation-based water remediation in accordance with one embodiment of the present invention, is presented generally at 500. In the current embodiment, method 500 may comprise flowing contaminated water through a remediation channel starting at an inlet, utilizing a pump to supply the water to the remediation channel, step 502

Still referring to FIG. 5, the method 500 may further comprise injecting at least one agent into the permeate water using an injection port in fluid communication with the remediation channel, step 504. The method 500 may further comprise introducing bursts of air into the fluid using air actuator in fluid communication with the remediation channel downstream from the injection port, step 506. The method 500 may further comprise flowing fluid through a reactor plate to create a cortex, step 508.

Still referring to FIG. 5, the method 500 may further comprise introducing bursts of air into the permeate water using air actuator at a second location in fluid communication with the remediation channel downstream from the injection port, step 510. The method 500 may further comprise generating at least one and more often a plurality of vortices vortex and cavitation pockets in the permeate water within the remediation channel step 512.

Still referring to FIG. 5, the method 500 may further comprise regulating a flow of the fluid using a flow regulation valve disposed within the remediation channel and in electronic communication with the air actuator, the flow regulation valve configured to optimize pressure to increase the number of cavitation pockets within the liquid, step 516. The method 500 may further comprise outputting the remediated permeate water into a reverse osmosis remediation system, step 516, and outputting the permeate water from the reverse osmosis system into the production storage tank and flowing the concentrate from the reverse osmosis system into a holding tank for further reprocessing through the remediation channel and the reverse osmosis system, step 518.

### EXAMPLE 1

The example is for the purpose of illustrating an embodiment and is not to be construed as a limitation.

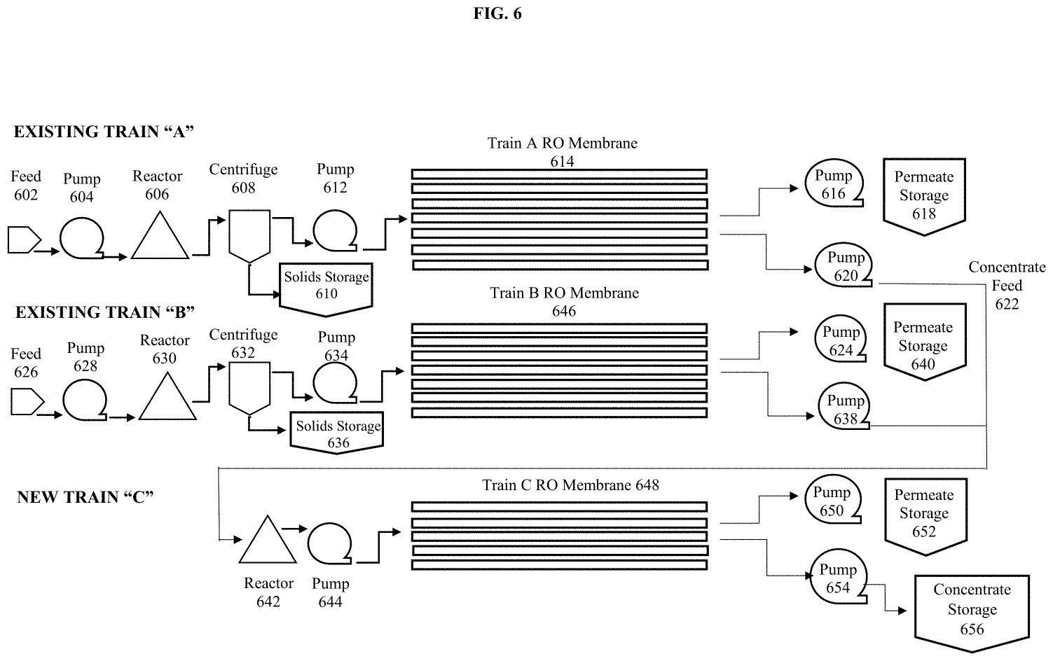

Referring now to FIG. 6, an optional embodiment of a large scale commercial implementation for a remediation system utilizing cavitation, is presented generally at 600. This optional embodiment considers the use of multiple trains of the system described herein. By coupling multiple trains together, this allows for the highest quality of remediation by passing the concentrate generated in train a and train b through its own reverse osmosis procedure. This is considered to be a multistage system where the concentrate from the first two stages become the feed water to the third stage. The use of additional stages allows for an increase in recovery of permeate water from the system. In even more optional embodiments on larger scales, more than 2 stages may be used before the concentrate is collected and processed.

Beginning with the existing Train A, the containment water is gathered from the feed 602. A pump 604 pushes the contaminated water towards the reactor 606 and centrifuge 608 that comprises the hydrodynamic cavitation system. Once the contaminated water is passed through the centrifuge 608, the solids are diverted to the solids storage tank 610 and the remaining water then sent to the train A RO membrane 614 through the pump 612, which is designed to provide enough pressure to cause reverse osmosis to occur as the water passes through the train A RO membrane 614. Once through the RO membrane 614, the permeate is sent to the permeate storage tank 618 via the pump 616, while the concentrate is sent to the concentrate feed 622 via the pump 620.

Still referring to FIG. 6, simultaneous with the operation of the existing train A, existing train B also operates. Train B begins when the contaminated water is gathered from the feed 626. A pump 628 then pushes the contaminated water towards the reactor 630 and centrifuge 632 where hydrodynamic cavitation takes place. Solids are diverted to the solids storage tank 636 while the remaining water is sent through the pump 634 to the train B RO membrane 646. Much like with train A, the pump 634 will provide enough pressure to cause reverse osmosis to occur as the water passes through the train B RO membrane 646. Once through the RO membrane 646, the permeate is sent to the permeate storage 640 via the pump 624, while the concentrate is sent to the concentrate feed 622 via the pump 638.

Still referring to FIG. 6, once both train A and train B are completed and the concentrate from both trains are sent to the concentrate feed 622, then train C will be performed. The reactor 642 receives the concentrate from the concentrate feed 622, which is then sent through the train C RO Membrane 648 via the pump 644. As with both Train A and Train B, the pump 644 is designed to generate enough pressure to cause reverse osmosis to occur as the concentrate passes through the train C RO Membrane 648. The permeate generated from the pass through the train C RO membrane 648 will be sent to the permeate storage 652 via the pump 650, while the remaining concentrate will be sent to the concentrate storage 656 via the pump 654.

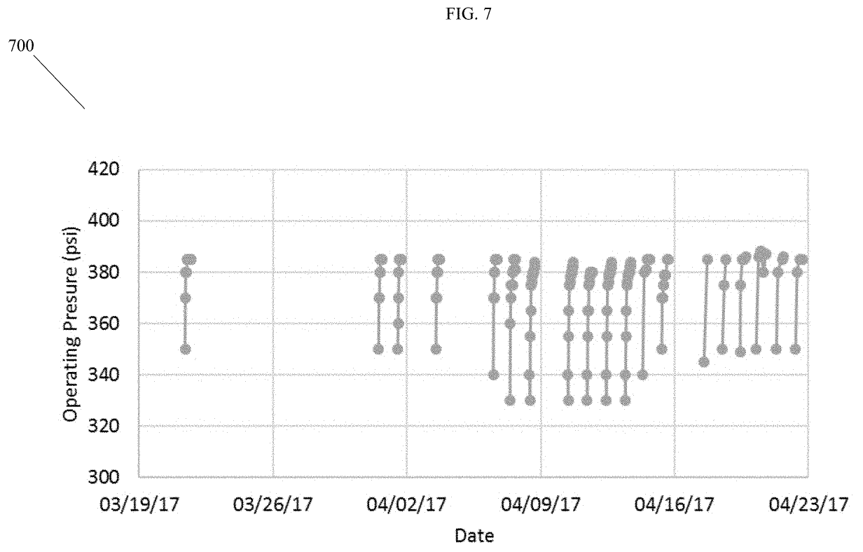

Referring now to FIG. 7, a table showing data taken from a test case utilizing the systems and methods provided for herein to perform remediation and cavitation, is presented generally at 700. The table 700 show the operating pressure on a day-by-day basis over the test period. Membrane operating pressure is an indicator of the amount of fouling of the membrane. At the start of each test, operating pressure was in the range of 330 to 350 psi. Pressure increased to 380 to 390 psi over the first four hours of each test and then remained steady for the remainder of the test. If the membranes were being progressively fouled, operating pressures would progressively increase over the course of the test period and would not return to baseline values at the conclusion of each test run. Operating pressures did not increase measurably over the test period, and thus the test data did not show apparent membrane fouling.

Referring now to FIG. 8, a front view of the reactor plate utilized in the system in accordance with one embodiment of the present invention, is presented generally at 800. With reference back to FIG. 1, the substantially homogenously mixed stream is directed from the air injector 116 to the reactor plate 146. The reactor plate 146 comprises a center aperture of a predetermined size through which the fluid passes. Uniform striations 802 are disposed of on the face of the reactor plate 146, the number of which is predetermined based upon the use-case and are configured to evenly disperse the fluid. The striations 802 in some embodiments are circular rings which form respective mountains and valleys over a predetermined portion of the face of the plate. In the embodiment shown generally at 800, the striations cover approximately half of the face of the plate from the outer radius inward. In some optional embodiments, the striations can act as seals with respect to the cavitation section. As can be seen in FIG. 1, flanges allow the sections to be easily replicable.

Still referring to FIG. 8, a vortex generation section 804 is disposed inwardly toward the center of the plate 146 and comprises a forward edge portion which slants first upwardly and rearwardly, and then curves in a continuous convex rearward curve, having valleys 808 and peaks 810 that blend into a substantially horizontal rearwardly extending to the upper edge portion. These peaks 810 may be referred to as “vanes.” This formation ensures that the bubbles begin forming at a size small enough to create a long range of hydrophobic forces that promotes bubble/particle attachment and creates optimum size and number of bubbles in a continually changing mixing environment. The reactor plate 146 enhances the amount of hydroxyl radicals generally may be capable of degrading and/or oxidizing organic compounds in a fluid, and results in significant amounts of oxidizing agents contained within and/or associated with the cavitation bubbles.

The reactor plate 146 may be formed of a material that is relatively impervious to cavitation's, such as a metal alloy, or in some embodiments, a resilient elastomeric material. The reactor plate 146 may be embodied in a variety of different shapes and configurations. For example, the plate may be conically shaped, including a conically-shaped surface that induces a vortex, or may be fully cyclical as shown. It should be appreciated other shapes may be employed as well to a varying degree.

Referring now to FIG. 9, a schematic of a fluid remediation system utilizing hydrodynamic cavitation together with an intelligent platform and automation hardware/software arrangement in accordance with one embodiment of the present invention, is shown generally at 900. “Intelligent platform,” generally, relates to controls such as programmable logic controls, high performance and high-performance system (e.g., PAC Systems) controllers, having availability redundancy, expandable open architectures, upgradeable CPUs and the like. Further, in embodiments of the present inventions, distributed I/O utilizing PROFINET® to maximize efficiency and data dissemination, have I/O flexibility and connect to a full range of I/O, from simple discrete to safety and process I/O.

As shown in FIG. 9, a PLC 902 is in electronically coupled (e.g., hardwire, wireless, Bluetooth®, etc.) with a plurality of controllers 904, 906, 908, each being coupled to various valves and sensor arrays. The PLC 902 is configured to execute software which continuously gathers data on the state of input devices to control the state of output devices. As is known, the PLC typically comprises a processor (which may include volatile memory), volatile memory comprising an application program, and one or more input/output (I/O) ports for connecting to other devices in the automation system. Additionally, in PLCs, context knowledge about the process available on control level is lost for the business analytics applications. The platform may further comprise higher level software functionality in Supervisory Control and Data Acquisition (SCADA), Manufacturing Execution Systems (MES), or Enterprise Resource Planning (ERP) systems. Optionally, the PLC may be an “Intelligent PLC,”, which comprises various components which may be configured to provide an assortment of enhanced functions in control applications. For example, in some embodiments, the Intelligent PLC includes a deeply integrated data historian and analytics functions. This technology is particularly well-suited for, but not limited to, various industrial automation settings for water remediation. In operations, the automation system context information may include, for example, one or more of an indication of a device that generated the data, a structural description of an automation system comprising the Intelligent PLC, a system working mode indicator, and information about a product that was produced when the contents of the process image area were generated. Additionally, or alternatively, the contextualized data may include one or more of a description of automation software utilized by the Intelligent PLC or a status indictor indicative of a status of the automation software while the contents of the process image area were generated.

Referring still to FIG. 9, the PLC is electronically coupled to a pump 124 and the fluid source 908, a sensor housing 106, a valve 910, a plurality of injector coils 110, an additive port 112 and another sensory array 114. An additional down-line controller 904 is communicatively coupled to the PLC and in further communication with the additive ports 112 and 138. In optional embodiments of the present invention, the sensor array 106 is configured to retrieve all of the relevant properties of fluid and send that information to the PLC for 902. Based on the properties of the fluid the PLC is configured to direct valves 914 to release agents into the stream that support the remediation process. The PLC 902, in some embodiments, is loaded with predetermined information regarding the quality of the fluid. By way of example, different types and combinations of precursor compounds in solid, liquid or gas phase depending upon the type of fluid treatment process selected, the contaminants to be treated, the existing water quality, the desired water quality, and other variables may be employed such as compounds that may comprise halogen salts such as fluorine, chlorine, bromine, iodine, sulfate salts, sodium or potassium or the like introduced as solids, or dissolved in water, or other solvent. An additional sensor array 912 is provided for testing and gathering data on the treated fluid, and to ensure proper pressures and flow rate may be provided.

First air injector 116 is in communication with an additional controller 906, which is in turn, in communication with PLC 902. In an optional embodiment of the present invention, the PLC 902 is configured to control air pressure based on the degree of cavitation required. The controller 906 is also in communication with the reactor plate 146 and a baffle (not shown) to rotate and tilt the reactor plate to vary the degrees of cavitation. Like the first air injector, a second air injector 120 and control valves 124 are in communication with the controller 906 for similar purposes.

Still with reference to FIG. 9, an additional actuator 918 may be employed, as may an optional sensor array 920 and UV reactor 922, each being connected to the controller before passing through the RO membrane 924 and becoming end use remediated water 926.

The first and second air injectors are configured to induce cavitation into the fluid to form vapor cavities in a liquid (i.e. small liquid-free zones, bubbles or voids), which occurs when the fluid is subjected to rapid changes of pressure that cause the formation of cavities where the pressure is relatively low. In this way, the injectors are used to enhance chemical reactions and propagate reactions due to free radical formation in the process due to disassociation of vapors trapped in the cavitating bubbles.

A reactor plate 146 is disposed within the line 101 between the first and second air injectors and is communication with the PLC 902, and the PLC 902 is configured to tilt the reactor plate 146 in various directions (e.g., 15 degrees). The reactor plate, discussed in greater with relation to FIG. 2, is configured to induce further cavitation such that, in the cavitation zone 144, there are large quantities of micro bubbles having high volatility.

An additional valve 124, e.g., butterfly valve, is disposed in the line to drop the head pressure when needed for egress of the fluid to outlet 104. The valve 124, like other valves in the system, is communicably coupled to the PLC such that it is fully autonomous.

While the present invention has been described in connection with what are presently considered to be the most practical and preferred embodiments, it is to be understood that the present invention is not limited to these herein disclosed embodiments. Rather, the present invention is intended to cover all of the various modifications and equivalent arrangements included within the spirit and scope of the appended claims.

Although specific features of various embodiments of the invention may be shown in some drawings and not in others, this is for convenience only. In accordance with the principles of the invention, the feature(s) of one drawing may be combined with any or all of the features in any of the other drawings. The words “including”, “comprising”, “having”, and “with” as used herein are to be interpreted broadly and comprehensively and are not limited to any physical interconnection. Moreover, any embodiments disclosed herein are not to be interpreted as the only possible embodiments. Rather, modifications and other embodiments are intended to be included within the scope of the appended claims.

We claim:

1. A method for preventing membrane fouling in a fluid treatment system having at least one membrane, the method comprising:
hydrodynamically cavitating a fluid flow prior to injecting it into the fluid treatment system and through the at least one membrane;
wherein after undergoing hydrodynamic cavitation in the cavitation reactor, solid components in the fluid change their (i) molecular structure, (ii) a charge, or both, such that the components repulse each other and disperse around an edge of the membrane to prevent fouling.

2. The method of claim 1, further comprising pumping a fluid to be treated into a first reverse osmosis train to produce a concentrate, wherein the reverse osmosis train comprises a plurality of membranes, the at least one membrane being one of the plurality of membranes.

3. The method of claim 2, further comprising receiving the concentrate at a hydrodynamic cavitation reactor, and introducing bursts of air into the concentrate using an air actuator.

4. The method of claim 1, further comprising processing the concentrate at the hydrodynamic cavitation reactor, and sending the concentrate through at least one membrane, wherein the at least one membrane comprises a first RO membrane or to a second RO membrane.

5. The method of claim 1, running the fluid through a centrifuge after hydrodynamically cavitating the fluid.

6. The method of claim 1, wherein the fluid is a concentrate that is a product of a first RO treatment, and the concentrate is run through the cavitation reactor prior to being run through a second RO treatment.

7. The method of claim 6, wherein after running the concentrate through the cavitation reactor, a mixture of solids is produced, the mixtures of solids comprising a calcium: magnesium ration of 18.6:1 and a calcium: potassium ration of 114:1.

8. A system for preventing membrane fouling in a fluid treatment system having at least one membrane, the method comprising:
a hydrodynamic cavitating reactor for cavitating a fluid flow prior to injecting it into the fluid treatment system and through the at least one membrane;
wherein after undergoing hydrodynamic cavitation in the cavitation reactor, solid components in the fluid change their (i) molecular structure, (ii) a charge, or both, such that the components repulse each other and disperse around an edge of the membrane to prevent fouling.

9. The system of claim 8, further comprising at least one pump configured to pump a fluid to be treated into a first reverse osmosis train to produce a concentrate, wherein the reverse osmosis train comprises a plurality of membranes, the at least one membrane being one of the plurality of membranes.

10. The system of claim 9, wherein the reactor receives the concentrate and introduces bursts of air into the concentrate using an air actuator.

11. The system of claim 8, further comprising a second membrane for processing the concentrate after the hydrodynamic cavitation reactor.

12. The system of claim 8, further comprising a centrifuge in fluid communication with cavitation reactor configured to remove particles from the fluid.

13. The system of claim 8, further comprising a second hydrodynamic cavitation reactor, and fluid inlets configured to send the concentrate through at least one membrane, wherein the at least one membrane comprises a first RO membrane or to a second RO membrane.

14. The system of claim 13, wherein after running the concentrate through the cavitation reactor, a mixture of solids is produced, the mixtures of solids comprising a calcium: magnesium ration of 18.6:1 and a calcium: potassium ration of 114:1.

15. The system of claim 8, wherein the membranes comprise lower pressure membranes.
